(19) United States
(12) Patent Application Publication
(10) Pub. No.: US 2014/0359442 A1
(43) Pub. Date: Dec. 4, 2014

(54) METHOD FOR SWITCHING AUDIO PLAYBACK BETWEEN FOREGROUND AREA AND BACKGROUND AREA IN SCREEN IMAGE USING AUDIO/VIDEO PROGRAMS

(71) Applicant: DynaLab (Singapore) Ltd., Singapore (SG)

(72) Inventor: Han-Hong LIN, Fenglin Township (TW)

(73) Assignee: DynaLab (Singapore) Ltd., Singapore (SG)

(21) Appl. No.: 14/291,950

(22) Filed: May 30, 2014

(30) Foreign Application Priority Data
Jun. 4, 2013 (TW) 102119740

(51) Int. Cl. G06F 3/16; G06F 3/0484

(52) U.S. Cl. CPC G06F 3/167; G06F 3/0484
USPC 715/716

(57) ABSTRACT

The present invention is to provide a method applicable to an electronic device having two programs stored therein and a display including a foreground and a background for creating a three-dimensional visual effect in the display, wherein one program presents a first image in the foreground in a prominent state and plays a sound corresponding to the first image, and the other program presents a second image in the background in a state other than the prominent state. When the electronic device determines that the second image is clicked, the electronic device switches the second image from the background to the foreground, changes the second image to the prominent state, plays a sound corresponding to the second image, switches the first image from the foreground to the background, changes the first image to the state other than the prominent state, and stops playing the sound corresponding to the first image.

### FIELD OF THE INVENTION

The present invention is to provide a method applicable to an electronic device having at least two audio/video programs stored therein and a display area including a foreground area and a background area for creating a three-dimensional visual effect in the display area, wherein one audio/vide program presents a first image in the foreground area in a prominent state and plays a sound corresponding to the first image, and the other audio/vide program presents a second image in the background area in a state other than the prominent state. When the electronic device determines that the second image is clicked by an input device, the electronic device switches the second image from the background area to the foreground area, changes the second image to the prominent state, plays a sound corresponding to the second image, switches the first image from the foreground area to the background area, changes the first image to the state other than the prominent state, and stops playing the sound corresponding to the first image. Thus, when a user is interested in the content provided by either of the audio/video programs, he or she can adjust the states of the audio/video programs so as to listen to the sound of only a single audio/video program and enjoy an enhanced user experience in the three-dimensional visual effect provided by the display area.

### BACKGROUND OF THE INVENTION

Recently, a vast variety of electronic devices such as personal digital assistants (PDAs), smartphones, and tablet PCs have been developed and brought to the market, thanks to the advancement of microcomputers and the rapid development of the electronics industry. As a result, people are forming the habit of obtaining everyday information or of entertaining themselves through such devices.

Generally speaking, today's electronic devices are designed to support multiplexing; that is to say, an electronic device can execute several programs simultaneously. For example, an audio/video program can be executed to play a multimedia file from an audio/video website (e.g., YouTube) while a browser displays news on a web page. If the news on the web page is presented in text, a reading program may be additionally activated through which the electronic device can read out the text in a word-by-word manner, allowing the user to understand the textual content rapidly and have an enhanced user experience. This is especially helpful to the elderly and those who are unable to focus on the screen all the time, but inconveniences in use follow. More specifically, when the audio-video program and the reading program are run at the same time, the audio output of the former is bound to interfere with that of the latter, making it impossible for the user to hear the desired content. The most common solution is to mute one of the programs so that the electronic device only plays the sound of the other program. The muted program and the sounding program can be switched when desired. Nevertheless, the operation required to mute and turn on the volume of different programs can be difficult for one who is not good at using electronic devices.

In addition, when an electronic device displays the visual content of different programs, the images are usually shown in a planar fashion. Therefore, the user is often confused as to which image on the screen corresponds to the sound being played. And because of that, the user cannot turn on or off the sound of a particular program rapidly, which is truly inconvenient. To sum up, when an electronic device executes multiple audio/video programs, not only do the audio outputs of the programs interfere with one another, but also the visual content of the programs is presented in such a way that the user tends to have problem identifying the source program of the sound being heard. Hence, it has been an important subject in the industry to find an effective solution to the aforesaid problems, sparing users the need to look for the muting or audio playback option of each audio/video program being executed.

### BRIEF SUMMARY OF THE INVENTION

In view of the various problems associated with an electronic device simultaneously executing multiple audio/video programs, in particular the complicated operation required to make the electronic device play the sound of only one of the audio/video programs, the inventor of the present invention conducted extensive research and experiment and finally succeeded in developing a method for switching audio playback between a foreground area and a background area in a screen image using audio/video programs. The present invention is intended to effectively solve the problems stated above.

It is an object of the present invention to provide a method for switching audio playback between a foreground area and a background area in a screen image using audio/video programs. The method is applicable to an electronic device which includes a processing unit, a storage unit, an input unit, an audio playback unit, and a display unit. The processing unit is separately electrically connected to the input unit, the storage unit, the audio playback unit, and the display unit. The storage unit stores at least two audio/video programs. The processing unit arranges a display area of the display unit in such a way that the display area includes a foreground area and a background area. The foreground area and the background area maintain their respective perspective directions and their perspective distance in a perspective space so as to create a three-dimensional visual effect in the display area. The first audio/video program presents a first display image in the foreground area and in a prominent state (e.g., in full frontal view or in an enlarged state) and plays the sound corresponding to the first display image through the audio playback unit. The second audio/video program presents a second display image in the background area and in a state other than the prominent state (e.g., in a tilted or scaled-down state in accordance with the perspective directions of, and the perspective distance between, the foreground area and the background area in the perspective space). After receiving a clicking message from the input unit and reading the content of the clicking message, the processing unit determines whether the second display image is clicked on. If yes, the processing unit switches the second display image from the background area to the foreground area, changes the second display image to the prominent state, and instructs the audio playback unit to play the sound corresponding to the second display image. At the same time, the processing unit switches the first display image from the foreground area to the background area, changes the first display image to the state other than the prominent state, and instructs the audio playback unit to stop playing the sound corresponding to the first display image. Thus, when the user is interested in the content provided by either of the audio/video programs, he or she can adjust the states of the audio/video programs so as to listen to the sound of only a single audio/video program and enjoy an enhanced user experience.

Another object of the present invention is to provide a method for switching audio playback between a foreground area and a background area in a screen image using audio/video programs, wherein the method is applicable to the same hardware structure as disclosed in the foregoing object and is characterized in that the foreground area overlaps the background area. More specifically, one of the audio/video programs presents a first display image in the foreground area and in a prominent state and plays the sound corresponding to the first display image via the audio playback unit. The other audio/video program presents a second display image in the background area in such a way that a portion of the second display image is covered by the first display image. After receiving a clicking message from the input unit, reading the content of the clicking message, and determining that the second display image is clicked on, the processing unit switches the second display image from the background area to the foreground area, changes the second display image to the prominent state, and instructs the audio playback unit to play the sound corresponding to the second display image. In the meantime, the processing unit switches the first display image from the foreground area to the background area, covers a portion of the first display image with the second display image, and instructs the audio playback unit to stop playing the sound corresponding to the first display image. The overlapping visual effect enables the user to rapidly know to which display image the sound being played corresponds.

### BRIEF DESCRIPTION OF THE SEVERAL VIEWS OF THE DRAWINGS

The objects, technical features, and effects of the present invention will be best understood by referring to the following detailed description of some illustrative embodiments in conjunction with the accompanying drawings, in which:

FIG. 1 is a hardware block diagram of an electronic device to which the present invention can be applied;

FIG. 2 schematically shows a perspective space in the present invention;

FIG. 3 schematically shows a display area in an embodiment of the present invention;

FIG. 4 schematically shows another display area in the embodiment depicted in FIG. 3;

FIG. 5 schematically shows a display area in another embodiment of the present invention; and

FIG. 6 schematically shows another display area in the embodiment depicted in FIG. 5.

### DETAILED DESCRIPTION OF THE INVENTION

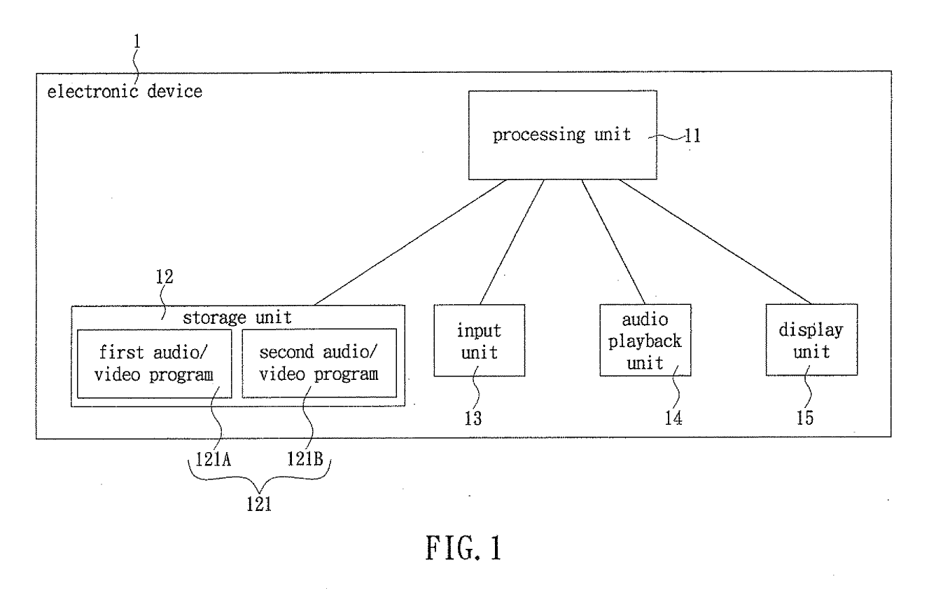

The present invention discloses a method for switching audio playback between a foreground area and a background area in a screen image using audio/video programs. In the first embodiment, referring to FIG. 1, the method is applied to an electronic device 1 such as a tablet computer, a touch screen television, a personal computer, a notebook computer, or the like. The electronic device 1 includes a processing unit 11, a storage unit 12, an input unit 13, an audio playback unit 14, and a display unit 15. The processing unit 11 is separately electrically connected to the storage unit 12, the input unit 13, the audio playback unit 14, and the display unit 15. It should be pointed out that while the input unit 13 and the display unit 15 are depicted here as separate components, it is feasible to integrate the input unit 13 and the display unit 15 as a single unit, such as a touch screen.

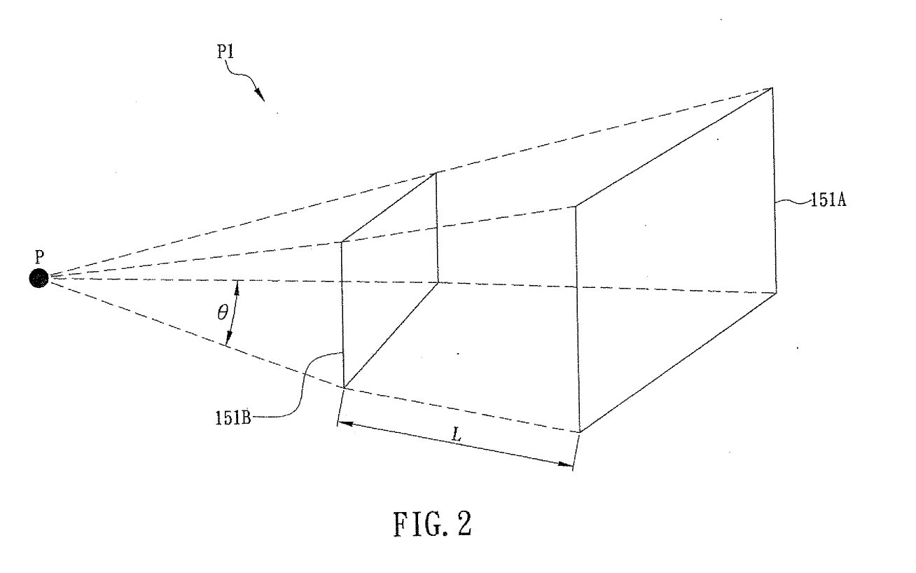

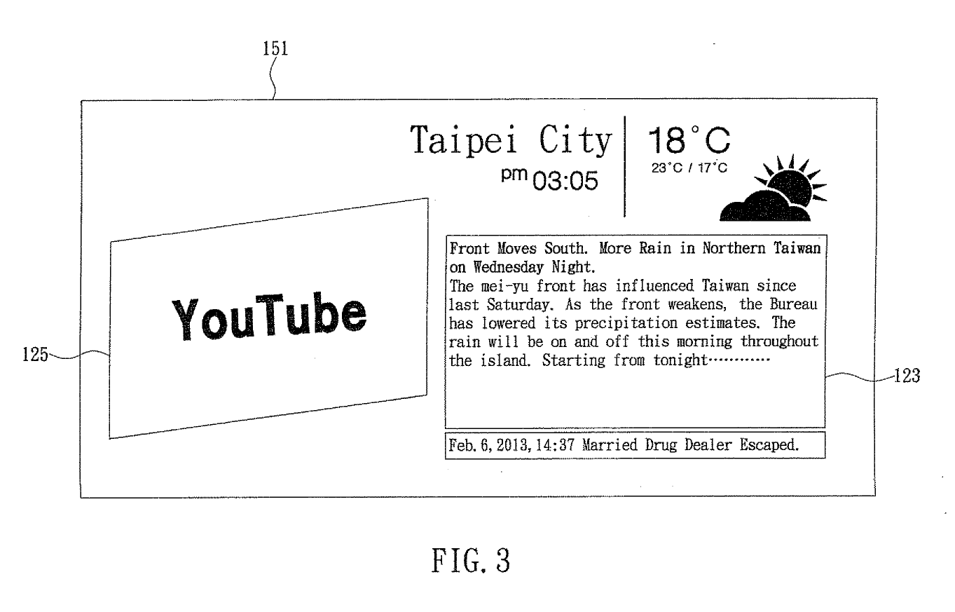

Referring to FIG. 1 to FIG. 3, the storage unit 12 stores at least two audio/video programs 121, namely a first audio/video program 121A and a second audio/video program 121B. The processing unit 11 arranges a display area 151 of the display unit 15 in such a way that the display area 151 includes a foreground area 151 A and a background area 151B, as shown in FIG. 2, which shows a perspective space P1 having a vanishing point P. Generally speaking, “perspective” refers to the presentation of a three-dimensional image on a two-dimensional plane. Therefore, in order to create a three-dimensional visual effect in the display area 151, the foreground area 151A and the background area 151B are fixed in different perspective directions (e.g., one in full frontal view and the other in a tilted state) and are spaced apart by a fixed perspective distance L in the perspective space P1. In the embodiment shown in FIG. 3, the first audio/video program 121A includes a transcription of news and works in combination with a reading program. Moreover, the first audio/video program 121A presents a first display image 123 in the foreground area 151A and in a prominent state (e.g., in full frontal view or an enlarged state) and plays the sound corresponding to the first display image 123 through the audio playback unit 14. The second audio/video program 121B is a program for playing files from the YouTube website and presents a second display image 125 in the background area 151B and in a state different from that of the first display image 123 (e.g., in a tilted or scaled-down state conforming to the perspective directions of, and the perspective distance L between, the foreground area and the background area in the perspective space P1). For example, the sizes and proportions of the foreground area 151A and the background area 151B can be changed by varying the angle θ in FIG. 2.

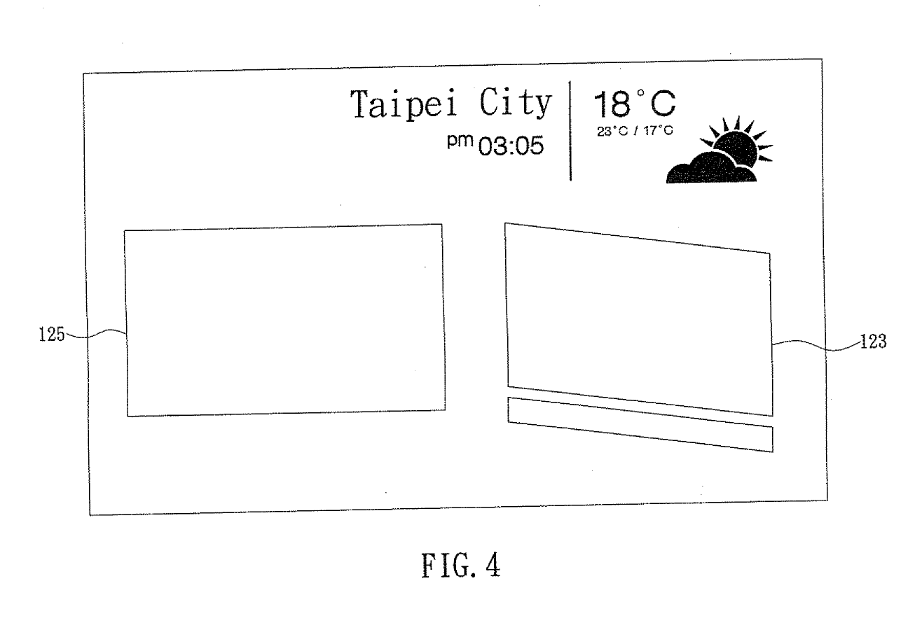

With continued reference to FIG. 1 to FIG. 3, when the user is more interested in the content of the second audio/video program 121B and wishes to view and listen to the content in detail, he or she can click on the second display image 125 of the second audio/video program 121B using the input unit 13 (e.g., a mouse or a touch screen). The input unit 13 will pack the data of the clicked-on second display image 125 into a clicking message and send the clicking message to the processing unit 11. The processing unit 11 receives the clicking message from the input unit 13 and reads the content of the clicking message. Upon determining that the second display image 125 is clicked on, the processing unit 11 switches the second display image 125 from the background area 151B to the foreground area 151A, changes the second display image 125 to the prominent state (as shown in FIG. 4), and instructs the audio playback unit 14 to play the sound corresponding to the second display image 125. In the meantime, the processing unit 11 switches the first display image 123 from the foreground area 151A to the background area 151B, changes the first display image 123 to a state different from that of the second display image 125, and instructs the audio playback unit 14 to stop playing the sound corresponding to the first display image 123. Thus, when seeing a content of interest, the user can easily adjust the states of the audio/video programs 121 and make the electronic device 1 play the sound of only a single audio/video program 121.

It should be noted that, referring to FIG. 1 to FIG. 3, the switching of the second display image 125 from the background area 151B to the foreground area 151A results only from a change in position of the vanishing point P; the second display image 125 and the first display image 123 do not swap positions. Moreover, the processing unit 11 in another embodiment of the present invention may, upon determining that the first or the second display image 123, 125 is clicked on, further determines whether the clicked-on first or second display image 123, 125 is in the background area 151B. Only if yes will the clicked-on first or second display image 123, 125 be switched from the background area 151B to the foreground area 151A.

As stated above, the processing unit 11 can instruct the audio playback unit 14 to play the sound corresponding to each audio/video program 121, and in practice, this can be done in two ways. Referring again to FIG. 1 to FIG. 3, the first way is for the processing unit 11 to instruct the first or the second audio/video program 121A, 121B, whichever corresponds to the one of the first and the second display images 123, 125 that is in the foreground area 151A, to play the sound corresponding to the one of the first and the second display images 123, 125 through the audio playback unit 14. In other words, both audio/video programs 121 will continue sending out their respective audio signals, but the processing unit 11 only transmits the sound of the audio/video program 121 corresponding to the foreground area 151A to the audio playback unit 14 for playback. The second way is for the processing unit 11 to instruct the first or the second audio/video program 121A, 121B, whichever corresponds to the one of the first and the second display images 123, 125 that is in the background area 151B, to stop the sound corresponding to the one of the first and the second display images 123, 125. In other words, the processing unit 11 will mute the audio/video program 121 corresponding to the background area 151B so that this audio/video program 121 ceases to send out audio signals; only the audio/video program 121 corresponding to the foreground area 151A continues sending out audio signals.

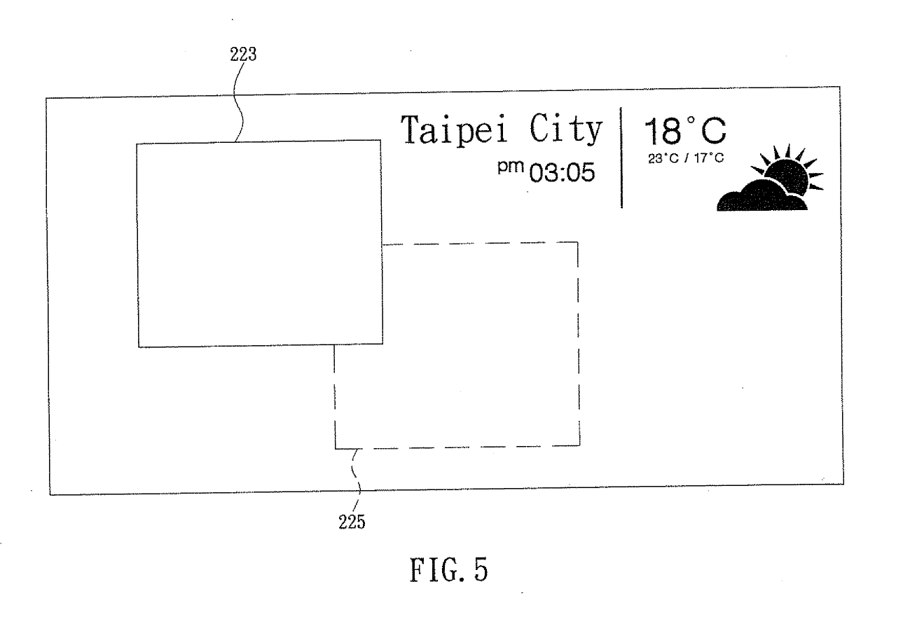

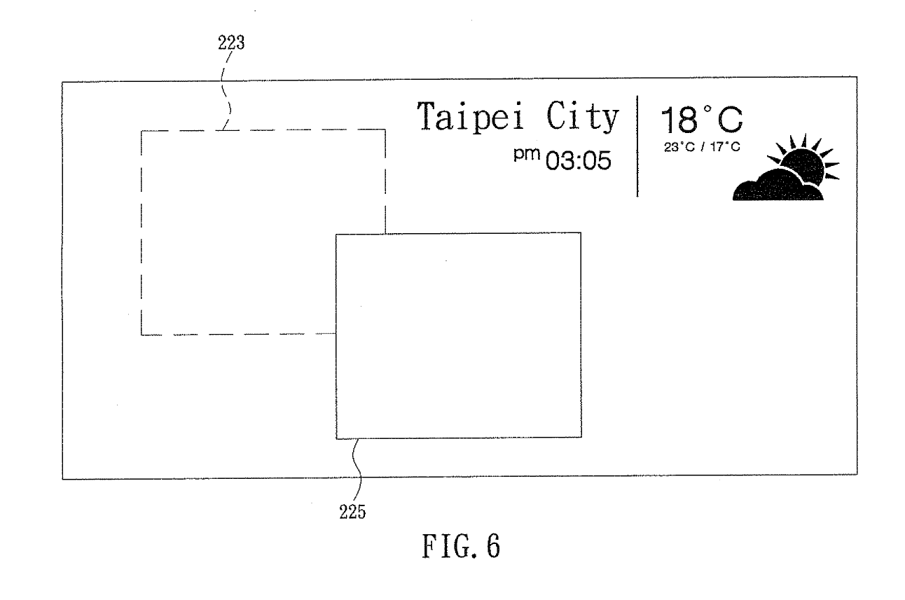

It is also feasible to distinguish the first and the second display images otherwise than generating a “perspective” visual effect in the display unit. For example, in another embodiment of the present invention, the display unit 15 displays the display images of the audio/video programs 121 in the following manner. Referring to FIG. 5 in conjunction with FIG. 1, the first audio/video program 121A presents a first display image 223 in a foreground area and in a prominent state and plays the sound corresponding to the first display image 223 via the audio playback unit 14. The second audio/video program 121B, on the other hand, presents a second display image 225 in a background area and has the second display image 225 overlapped by the first display image 223. In other words, the first display image 223 in the foreground area is presented in full while the second display image 225 in the background area is partially covered by the first display image 223. Once the processing unit 11 receives and reads the content of the clicking message sent by the input unit 13 and determines that the second display image 225 is clicked on, the processing unit 11 switches the second display image 225 from the background area to the foreground area, changes the second display image 225 to the prominent state, and instructs the audio playback unit 14 to play the sound corresponding to the second display image 225. At the same time, the processing unit 11 switches the first display image 223 from the foreground area to the background area (as shown in FIG. 6), with the second display image 225 covering a portion of the first display image 223 in the background area, and instructs the audio playback unit 14 to stop playing the sound corresponding to the first display image 223. Thus, the user can easily tell from which audio/video program 121 the sound being heard comes.

While the invention herein disclosed has been described by means of specific embodiments, numerous modifications and variations could be made thereto by those skilled in the art without departing from the scope of the invention set forth in the claims.

What is claimed is:

1. A method for switching audio playback between a foreground area and a background area in a screen image using audio/video programs, the method being applicable to an electronic device, the electronic device including a processing unit, a storage unit, an input unit, an audio playback unit, and a display unit, wherein the processing unit is separately electrically connected to the input unit, the storage unit, the audio playback unit, and the display unit; the storage unit stores at least two audio/video programs; the processing unit arranges a display area of the display unit in such a way that the display area includes a foreground area and a background area, the foreground area and the background area maintaining their respective perspective directions and their perspective distance in a perspective space so as to create a three-dimensional visual effect in the display area; one of the audio/video programs presents a first display image in the foreground area and in a prominent state and plays a sound corresponding to the first display image through the audio playback unit; and the other of the audio/video programs presents a second display image in the background area and in a state other than the prominent state, the method comprising the steps, to be performed by the processing unit, of:
receiving a clicking message from the input unit, and reading a content of the clicking message; and
switching the second display image from the background area to the foreground area, changing the second display image to the prominent state, instructing the audio playback unit to play a sound corresponding to the second display image, switching the first display image from the foreground area to the background area, changing the first display image to the state other than the prominent state, and instructing the audio playback unit to stop playing the sound corresponding to the first display image, upon determining that the second display image is clicked on.

2. The method of claim 1, wherein the processing unit instructs whichever of the audio/video programs that corresponds to one of the first and the second display images that is presented in the foreground area to play the sound corresponding to the one of the first and the second display images through the audio playback unit.

3. The method of claim 1, wherein the processing unit instructs whichever of the audio/video programs that corresponds to one of the first and the second display images that is presented in the background area to stop the sound corresponding to the one of the first and the second display images.

4. The method of claim 2, wherein the prominent state comprises being in full frontal view or an enlarged state.

5. The method of claim 3, wherein the prominent state comprises being in full frontal view or an enlarged state.

6. The method of claim 4, wherein the state other than the prominent state comprises being in a tilted or scaled-down state in accordance with the perspective directions of, and the perspective distance between, the foreground area and the background area in the perspective space.

7. The method of claim 5, wherein the state other than the prominent state comprises being in a tilted or scaled-down state in accordance with the perspective directions of, and the perspective distance between, the foreground area and the background area in the perspective space.

8. A method for switching audio playback between a foreground area and a background area in a screen image using audio/video programs, the method being applicable to an electronic device, the electronic device including a processing unit, a storage unit, an input unit, an audio playback unit, and a display unit, wherein the processing unit is separately electrically connected to the input unit, the storage unit, the audio playback unit, and the display unit; the storage unit stores at least two audio/video programs; the processing unit arranges a display area of the display unit in such a way that the display area includes a foreground area and a background area, the foreground area overlapping the background area; one of the audio/video programs presents a first display image in the foreground area and in a prominent state and plays a sound corresponding to the first display image through the audio playback unit, and the other of the audio/video programs presents a second display image in the background area in such a way that the first display image covers a portion of the second display image, the method comprising the steps, to be performed by the processing unit, of:
receiving a clicking message from the input unit, and reading a content of the clicking message; and
switching the second display image from the background area to the foreground area, changing the second display image to the prominent state, instructing the audio playback unit to play a sound corresponding to the second display image, switching the first display image from the foreground area to the background area, covering a portion of the first display image with the second display image, and instructing the audio playback unit to stop playing the sound corresponding to the first display image, upon determining that the second display image is clicked on.

9. The method of claim 8, wherein the processing unit instructs whichever of the audio/video programs that corresponds to one of the first and the second display images that is presented in the foreground area to play the sound corresponding to the one of the first and the second display images through the audio playback unit.

10. The method of claim 8, wherein the processing unit instructs whichever of the audio/video programs that corresponds to one of the first and the second display images that is presented in the background area to stop the sound corresponding to the one of the first and the second display images.
